(19) United States
(12) Patent Application Publication
(10) Pub. No.: US 2024/0372311 A1
(43) Pub. Date: Nov. 7, 2024

(54) OPTICAL FIBER OUTPUT LIGHT SOURCE DEVICE, AND SINGLE-POLARIZATION REFLECTIVE POLARIZING BEAM SPLITTER USED THEREIN

(71) Applicants: KINKI UNIVERSITY, Osaka (JP); OPTOQUEST CO., LTD., Saitama (JP)

(72) Inventors: Minoru YOSHIDA, Osaka (JP); Yuichi TAKUSHIMA, Kanagawa (JP); Shota SEKIGUCHI, Saitama (JP); Yoshiharu SUZUKI, Saitama (JP); Tadashi HAJIKANO, Saitama (JP); Xiaomin WANG, Tokyo (JP)

(73) Assignees: KINKI UNIVERSITY, Osaka (JP); OPTOQUEST CO., LTD., Saitama (JP)

(21) Appl. No.: 18/573,138

(22) PCT Filed: Jun. 24, 2022
(86) PCT No.: PCT/JP2022/025262

§ 371 Date: Jul. 23, 2024

(30) Foreign Application Priority Data
Jun. 24, 2021 (JP) 2021-104607

(51) Int. Cl. H01S 3/10; G02B 27/28; G02F 1/383; H01S 3/067; H01S 3/108

(52) U.S. Cl. CPC H01S 3/10061; G02B 27/283; G02B 27/286; G02F 1/383; H01S 3/06754; H01S 3/108

(57) ABSTRACT

An optical fiber output light source device includes an optical path that is obtained by joining a polarization maintaining amplifying optical fiber to a polarization maintaining dispersion compensating fiber, a single-polarization reflective polarizing beam splitter that is joined to one end of the optical path, a 90° polarization-rotating reflector that is joined to the other end of the optical path, a multiplexer that is inserted in the optical path, and a pumping light source that is joined to the multiplexer. An axis roll connection portion is provided in which a polarization axis of light returned from the single-polarization reflective polarizing beam splitter to the optical path is connected to a polarization maintaining axis of the optical path with a twisting angle therebetween at a predetermined angle.

### TECHNICAL FIELD

The present invention relates to an optical fiber output light source device, and a single-polarization reflective polarizing beam splitter used therein.

### BACKGROUND ART

A white light source is an important device for use in measuring the wavelength dependent characteristics of an optical fiber or an optical component. Conventionally, to obtain a white light source, light from a halogen lamp or the like is collected into a fiber and is emitted from the fiber. However, the core diameter of the fiber is around 10 μm, and the luminance from the surface of the filament used in the halogen lamp is limited. Therefore, high light output cannot be achieved even in a case where light is concentrated in the fiber.

To achieve high light output, a fiber laser may be used in which a fiber is doped with rare-earth elements and is pumped by a semiconductor laser. However, because of its narrow spectrum width, the fiber laser cannot be a substitute for a white light source.

On the other hand, there exists an amplified spontaneous emission (ASE) light source, in which excitation is performed to a point right before when laser oscillation would occur, and a fluorescent component in which stimulated amplification is occurring slightly is taken out of the fiber.

PTL 1 discloses a technique in which, in a case of turning output light from a short pulse light source into multiwavelength light with use of an optical amplifier and a nonlinear optical medium, a noise component (ASE light component) generated from the optical amplifier is reduced. Specifically, the ASE light component is reduced by using a nonlinear optical effect of an anomalous dispersion optical waveguide provided between the optical amplifier and the nonlinear optical medium.

Furthermore, as a recent technique, the following technique (super continuum (SC) light source) is being put into practical use. Pulses generated in a fiber are made incident on a photonic bandgap fiber or the like having a high nonlinear optical effect to obtain broadband pulses.

PTL 2 discloses a method in which fundamental pulses emitted from a device that generates ultrashort picosecond-or-less pulses of laser light are turned into broadband pulses by using a self-phase modulation effect, which is achieved by making the fundamental pulses pass through a nonlinear optical substance.

However, the ASE light source described in PTL 1 and the like does not seem to have a sufficiently high fiber output for use as a white light source. Furthermore, the SC light source disclosed in PTL 2 and the like achieves a spectrum width of one octave or more. However, since the nonlinear optical effect changes due to the fluctuation of incident pulses, it is difficult to obtain a stable light source. That is, since the light source is unstable when broadband or high-luminance emission is obtained, it is difficult to perform a high-accuracy evaluation.

To cope with these problems, PTL 3 describes a light source configuration capable of providing a stable and high-luminance broadband light source. In the light source described in PTL 3, an optical path including an amplifying optical fiber is interposed between a 90° polarization-rotating reflector and a single-polarization reflective polarizing beam splitter. By using this configuration, a normal continuous oscillation operation becomes restricted, and nonlinear polarization rotation, which enables laser oscillation, occurs only in a case where the nonlinear optical effect arises.

PTL 3 describes that, under such conditions, pulses are generated only at the time of intense laser oscillation, and these pulses constitute a bunch of ultra-short pulses of about 100 fs. Therefore, a broadband spectrum characteristic can be obtained due to the nonlinearity caused by the bunch of ultra-short pulses. Consequently, a stable, broadband, and high intensity light source can be provided.

### CITATION LIST

### Patent Literature

PTL 1: Japanese Patent Application Laid-Open No. 2007-178681
PTL 2: Japanese Patent Application Laid-Open No. 2001-083558
PTL 3: Japanese Patent No. 6731684

### Non Patent Literature

NPL 1: M. Martinelli, “A universal compensator for polarization changes induced by birefringence on a retracing beam,” Opt. Commun., vol. 72, no. 6, pp. 341-344, 1989

### SUMMARY OF INVENTION

### Technical Problem

In the light source in PTL 3, the polarization of the light that has returned to the 90° polarization-rotating reflector from the single-polarization reflective polarizing beam splitter has been rotated by 90° and the light is then returned to the single-polarization reflective polarizing beam splitter. Hence, the light passes through the single-polarization reflective polarizing beam splitter as is. That is, the light source in PTL 3 is basically unable to confine laser light.

For this reason, the light source in PTL 3 relies on accidental occurrence of a favorable nonlinear polarization rotation to start oscillation in the optical path, and this light source thus faces problems in its difficulty in starting oscillation. Furthermore, the light source in PTL 3 has a possibility of a change in the state of the nonlinear polarization rotation, due to disturbances such as temperature and external pressure. As a result, the light source in PTL 3 is problematic in that light-emitting characteristics from the light source may change, or in that laser oscillation may suddenly stop.

In other words, the configuration of the laser resonator in which the single-polarization reflective polarizing beam splitter and the 90° polarization-rotating reflector are joined via the optical fiber is problematic in that it is difficult to start oscillation and in that the oscillation state is not stable because of disturbances applied to the optical fiber.

### Solution to Problem

The present invention has been conceived in view of such problems discussed above, and provides a broadband light source that not only takes advantage of PTL 3 but also achieves a stable start to oscillation and a long period of sustained oscillation without the need to have a control mechanism such as a polarization controller that controls polarization in response to the disturbances.

More specifically, an optical fiber output light source device according to the present invention includes:
an optical path that is obtained by joining a polarization maintaining amplifying optical fiber to a polarization maintaining dispersion compensating fiber; a single-polarization reflective polarizing beam splitter that is joined to one end of the optical path;
a 90° polarization-rotating reflector that is joined to the other end of the optical path;
a multiplexer that is inserted in the optical path; and
a pumping light source that is joined to the multiplexer,
wherein an axis roll connection portion is provided in which a polarization axis of light returned from the single-polarization reflective polarizing beam splitter to the optical path is connected to a polarization maintaining axis of the optical path with a twisting angle therebetween at a predetermined angle.

### Advantageous Effects of Invention

Due to the combination of the 90° polarization-rotating reflector, the single-polarization reflective polarizing beam splitter, and the polarization maintaining fiber in the optical path in the present configuration, broadband short pulses can be generated. These pulses constitute a bunch of ultra-short pulses of about 100 fs. A broadband spectrum characteristic can be obtained due to the nonlinearity caused by the bunch of the ultra-short pulses.

Furthermore in the optical fiber output light source device according to the present invention, there is no need for adjustment to cause nonlinear polarization rotation (suitable) to start laser oscillation. In the optical fiber output light source device according to the present invention, in the axis roll connection portion, the polarization axis of the single-polarization reflective polarizing beam splitter and the polarization maintaining axis of the polarization maintaining fiber are twisted by the predetermined twisting angle and connected. Therefore, light subjected to nonlinear polarization rotation favorable for laser oscillation is supplied to the single-polarization reflective polarizing beam splitter.

Accordingly, when light with sufficient gain, due to an increase in the power of the input light, is input into the polarization maintaining fiber, the stable nonlinear polarization rotation favorable for oscillation is supplied at the axis roll connection portion. Thus, laser oscillation is started and maintained without any kind of adjustment. Accordingly, the optical fiber output light source device can start up quickly.

Furthermore, in the axis roll connection portion, the polarization axis of the single-polarization reflective polarizing beam splitter and the polarization maintaining axis of the polarization maintaining fiber are twisted by the predetermined twisting angle and connected. Therefore, even in a case where unexpected changes of nonlinear polarization occur in the optical path due to disturbances, light returned to the single-polarization reflective polarizing beam splitter includes, at a certain proportion, light having nonlinear polarization rotation favorable for laser oscillation. Accordingly, the laser oscillation state is unlikely to be influenced by disturbances, and laser oscillation that is stable for a long time can be obtained.

### BRIEF DESCRIPTION OF DRAWINGS

FIG. 1 is a diagram illustrating a configuration of an optical fiber output light source device according to the present invention.

FIG. 2 is a diagram illustrating an internal configuration of a single-polarization reflective polarizing beam splitter.

FIG. 3 includes diagrams illustrating a polarization axis on an input side of a polarizing beam splitter of the single-polarization reflective polarizing beam splitter and a polarization maintaining axis at an exit end of an optical path fiber.

FIG. 4 is a diagram illustrating a configuration in which an axis roll connection portion is separated from the single-polarization reflective polarizing beam splitter and provided in an optical path.

FIG. 5 is a diagram illustrating a configuration of an axis roll connection portion, in which a ½ wave plate is provided at the connection portion between an input pigtail fiber and the optical path fiber.

FIG. 6 is a diagram illustrating a configuration obtained by incorporating an axis roll connection portion in the single-polarization reflective polarizing beam splitter.

FIG. 7 is a diagram illustrating a conventional configuration in PTL 3.

FIG. 8 is a diagram describing an examination method of examining whether or not the axis roll connection portion is formed in a resonator.

FIG. 9 is a graph showing an output light spectrum in the configuration of FIG. 4.

FIG. 10 is a graph showing an output light spectrum in the case of FIG. 7 in which the polarization maintaining fiber is not used.

FIG. 11 is a graph showing measurement results for output light power from the single-polarization reflective polarizing beam splitter when given a varying twisting angle θ between the polarization axis of the single-polarization reflective polarizing beam splitter and the polarization maintaining axis of the optical path.

FIG. 12 is a graph showing the result of an output light spectrum when the axis roll connection portion illustrated in FIG. 5 is used.

FIG. 13 is a graph showing the result of an output light spectrum when a highly nonlinear fiber is connected to a latter part relative to FIG. 12.

FIG. 14 is a graph showing the result of an output light spectrum during the oscillation of a laser in which the single-polarization reflective polarizing beam splitter integrated with a ½ wave plate as illustrated in FIG. 6 is installed.

### DESCRIPTION OF EMBODIMENTS

An optical fiber output light source device according to the present invention will be described below with reference to the drawings and examples. Note that the following description is intended to illustrate some parts of embodiments and examples of the present invention, and the present invention is not limited to the following description. The following description can be modified without departing from the spirit of the present invention.

### Overall Configuration

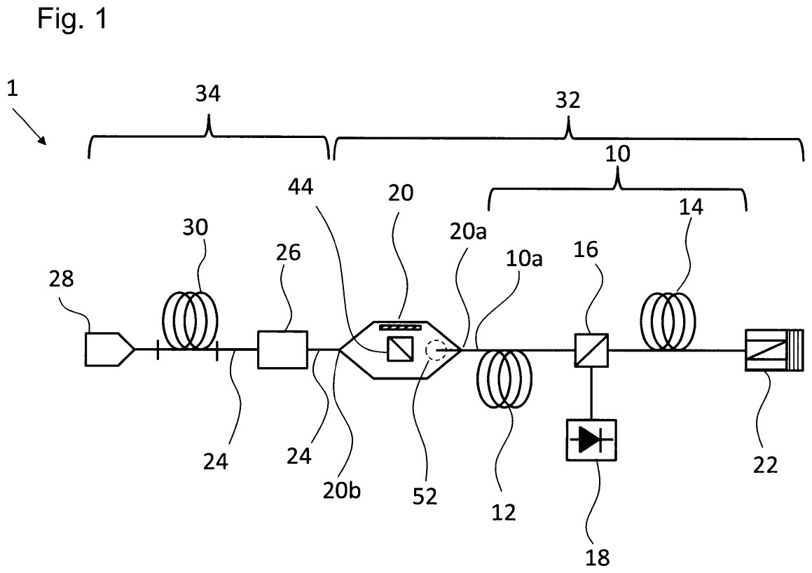

FIG. 1 illustrates a configuration of an optical fiber output light source device 1 according to the present invention. The optical fiber output light source device 1 includes a resonator 32. An output unit 34 may be connected to the latter part relative to the resonator 32. In the resonator 32, a 90° polarization rotating reflector 22 is arranged at one end of an optical path 10, and a single-polarization reflective polarizing beam splitter 20 is arranged at the other end of the optical path 10.

The single-polarization reflective polarizing beam splitter 20 has an incident port 20a and an exit port 20b. The optical path 10 is joined to the incident port 20a, and the output unit 34 is joined to the exit port 20b. The output unit 34 includes an anti-reflector 26, a highly nonlinear fiber 30, a light-emitting port 28, and the like. Hereinafter, the respective components will be described in detail.

### <Optical Path>

The optical path 10 is formed by joining a dispersion compensating fiber (DCF) 12 to an amplifying optical fiber 14. Furthermore, a multiplexer 16 is inserted in the optical path 10. The dispersion compensating fiber 12 may be provided anywhere in the optical path 10. Furthermore, the dispersion compensating fibers 12 may be provided at multiple positions in the optical path 10. The dispersion compensating fiber 12 may be provided between the multiplexer 16 and the amplifying optical fiber 14.

As the amplifying optical fiber 14, an optical fiber doped with rare-earth elements such as Er (erbium), Pr (praseodymium), and Tm (thulium) can preferably be used. An erbium doped optical fiber (EDF) can preferably be used.

Note that both the dispersion compensating fiber 12 and the amplifying optical fiber 14 are polarization maintaining fibers. The dispersion compensating fiber 12 and the amplifying optical fiber 14 are joined, with the fast axes and slow axes (the fast axis and the slow axis are collectively referred to as “polarization maintaining axes”) thereof aligned with each other. That is, the dispersion compensating fiber 12 and the amplifying optical fiber 14 are joined, with the fast axes of the fibers aligned with each other, and with the slow axes of the fibers aligned with each other. The type of each of the polarization maintaining fibers is, for example, a PANDA type or a BowTie type. However, the type is not limited to a particular one but may be any type in which the interference between the polarized waves that pass through the fast axes or the slow axes is sufficiently small.

A fiber obtained by joining the dispersion compensating fiber 12 to the amplifying optical fiber 14 in the optical path 10 is called an optical path fiber 10a. One end of the optical path fiber 10a is a terminal end joined to the 90° polarization-rotating reflector 22 while the other end thereof is a terminal end joined to the single-polarization reflective polarizing beam splitter 20.

### [Multiplexer]

The multiplexer 16 is a coupler that supplies the optical path 10 with pumping light. The multiplexer 16 is joined to a pumping light source 18. As the pumping light source 18, a laser diode can preferably be used.

The multiplexer 16 may transmit pumping light to the amplifying optical fiber 14 from either the side where the single-polarization reflective polarizing beam splitter 20 is joined or the side where the 90° polarization-rotating reflector 22 is joined. However, as illustrated in FIG. 1, the pumping light is most preferably transmitted toward the amplifying optical fiber 14 joined to the 90° polarization-rotating reflector 22.

### <90° Polarization-Rotating Reflector>

The 90° polarization-rotating reflector 22 is provided at the one end of the optical path 10. The 90° polarization-rotating reflector 22 is a reflector that rotates the polarization plane of incident light to emit reflected light having the polarization plane thereof rotated by 90°. For example, as the 90° polarization-rotating reflector 22, a Faraday rotating mirror can preferably be adopted. Note that the rotating angle of the polarization plane may be practically 90°. Furthermore, the 90° polarization-rotating reflector 22 may include a plurality of components that have an effect of rotating the polarization plane of incident light to emit reflected light having the polarization plane thereof rotated by 90°.

Furthermore, the 90° polarization-rotating reflector 22 is not limited to a Faraday rotating mirror. For example, any configuration can be used as the 90° polarization-rotating reflector 22 as long as the configuration exhibits a similar effect by using an optical system that controls the polarization state that results from birefringence caused by a fiber used between the incident port 20a of the single-polarization reflective polarizing beam splitter 20, which will be described below, and the reflecting mirror provided at the position of the 90° polarization-rotating reflector 22.

More specifically, first, the 90° polarization-rotating reflector 22 is replaced with a normal dielectric multilayer mirror. Then, the setting is arranged so that the birefringence caused by the fiber provided between the incident port 20a and the incident end of the dielectric multilayer mirror is compensated for, and so that the polarization is rotated by 90° while the polarized wave maintains the linear state when the reflected light returns to the single-polarization reflective polarizing beam splitter 20. Note that the dielectric multilayer mirror may be a metal deposition mirror or the like.

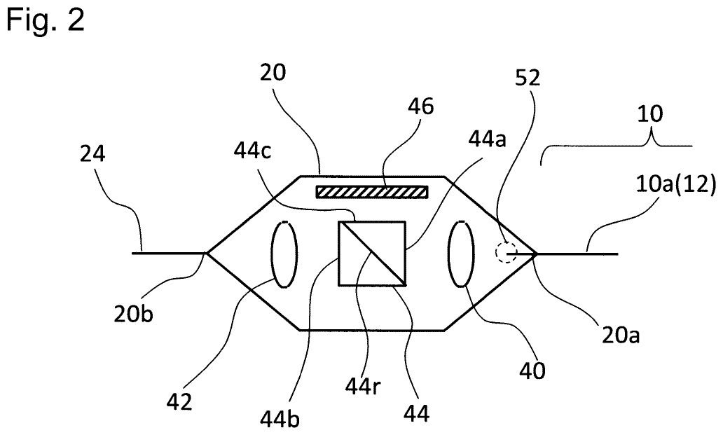

Furthermore, the polarization state is controlled using a wave plate or the like so that the reflected light from the dielectric multilayer mirror passes through a reflection surface 44r, which is in a polarizing beam splitter 44 (refer to FIG. 2) in the single-polarization reflective polarizing beam splitter 20, without reflection and is output through the exit port 20b at a high rate. In a case of using such a configuration as the 90° polarization-rotating reflector 22, a similar effect to that in a case of using the Faraday rotating mirror can be achieved, and pulsed oscillation can occur.

### <Single-Polarization Reflective Polarizing Beam Splitter>

The single-polarization reflective polarizing beam splitter 20 is provided at the other end of the optical path 10. The single-polarization reflective polarizing beam splitter 20 reflects only light having one polarization plane and transmits light having the other polarization plane out of the two polarization planes orthogonal to each other. The reflected light is returned to the optical path 10. Therefore, the single-polarization reflective polarizing beam splitter 20 has the incident port 20a and the exit port 20b. The optical path 10 is joined to the incident port 20a.

FIG. 2 illustrates an internal configuration of the single-polarization reflective polarizing beam splitter 20. The single-polarization reflective polarizing beam splitter 20 includes an incident lens 40, an exit lens 42, the polarizing beam splitter 44, and a reflecting mirror 46. Furthermore, at a position past the incident lens 40, going toward the side provided with the optical path 10, an axis roll connection portion 52, which will be described below, is provided. The incident lens 40 is arranged to be immediately after the incident port 20a (at the latter part relative to the single-polarization reflective polarizing beam splitter 52). In other words, in the single-polarization reflective polarizing beam splitter 20, the incident lens 40 is arranged at a position optically opposed to the other end of the optical path fiber 10a via the axis roll connection portion 52.

The exit lens 42 is arranged to be immediately before the exit port 20b in the single-polarization reflective polarizing beam splitter 20. The end surfaces corresponding to the incident port 20a and the exit port 20b in the single-polarization reflective polarizing beam splitter 20 are subjected to an anti-reflection treatment that prevents Fresnel reflection generated at an interface between the end surface and the air. The treated end surfaces are for preventing an unexpected laser resonator from being formed inadvertently. Note that the incident lens 40 and the exit lens 42 each may be called a collimator.

The polarizing beam splitter 44 is arranged between the incident lens 40 and the exit lens 42. The polarizing beam splitter 44 includes therein the reflection surface 44r that transmits only a specific polarization plane. The polarizing beam splitter 44 also includes an incident light surface 44a that allows light to enter, a transmitted light surface 44b that emits only light having a specific polarization plane, and a reflected light surface 44c that emits light whose polarization plane is rotated by 90° with respect to the transmitted light.

In the present specification, a description will be provided, with the reflected light as an S wave, and with the transmitted light as a P wave. The polarization axis that allows the P wave to be transmitted is called a P axis. Furthermore, the axis in the direction perpendicular to the P wave is called an S axis. The S axis can be called a polarization axis that reflects the S wave. The S axis and the P axis are polarization axes of the polarizing beam splitter 44.

### <Axis Roll Connection Portion>

Referring to FIG. 1 again, the optical fiber output light source device 1 according to the present invention is provided with the axis roll connection portion 52 at a portion at which the single-polarization reflective polarizing beam splitter 20 and the optical path fiber 10a are joined. The axis roll connection portion 52 is a portion at which the polarization maintaining axes of the polarization maintaining fiber that forms the optical path 10 and the polarization axes of the single-polarization reflective polarizing beam splitter 20 are intentionally twisted and connected.

The polarization maintaining axes of the polarization maintaining fiber and the P axis of the polarizing beam splitter 44 in the single-polarization reflective polarizing beam splitter 20 are twisted and connected, facilitating the oscillation of the optical fiber laser and making it less susceptible to disturbances. Such an effect gives excellent usability to the optical fiber output light source device 1.

### [Basic Type]

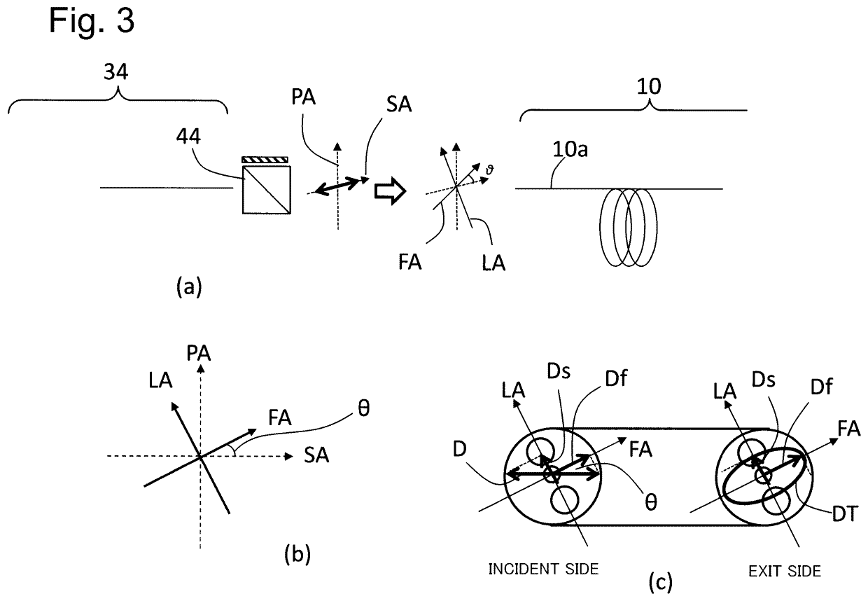

FIG. 3 illustrates the polarization axes on the input side of the polarizing beam splitter 44 of the single-polarization reflective polarizing beam splitter 20 and the polarization maintaining axes on the exit end of the optical path fiber 10a. FIG. 3 (a) is a schematic view illustrating a connection state of the polarization axes and the polarization maintaining axes. FIG. 3 (b) is a diagram in which the polarization axes and the polarization maintaining axes that are in an overlapped state are viewed from the side provided with the optical path 10.

Note that the polarization axes of the polarizing beam splitter 44 may be the polarization axes of the single-polarization reflective polarizing beam splitter 20. The single-polarization reflective polarizing beam splitter 20 includes two orthogonal axes including an S axis SA that reflects the S wave and a P axis PA that transmits the P wave.

Then, a fast axis FA and a slow axis LA at the exit end of the optical path fiber 10a are twisted by a predetermined angle θ with respect to the polarization axes and connected thereto (refer to FIG. 3 (b)). In other words, the fast axis FA and the slow axis LA at the exit end of the optical path fiber 10a are rotated by the predetermined angle θ and connected thereto. The angle θ is also called a twisting angle θ.

The axis roll connection portion 52 refers to a portion in which the polarization axes of the single-polarization reflective polarizing beam splitter 20 and the polarization maintaining axes of the optical path fiber 10a are twisted by the angle θ and connected, or a portion in which these are connected in a state where the twisting angle θ is variable. Furthermore, twisting the polarization axes of the single-polarization reflective polarizing beam splitter 20 and the polarization maintaining axes of the optical path fiber 10a by the twisting angle θ and connecting them may be expressed as twisting the axes each other.

### [Pigtail Type]

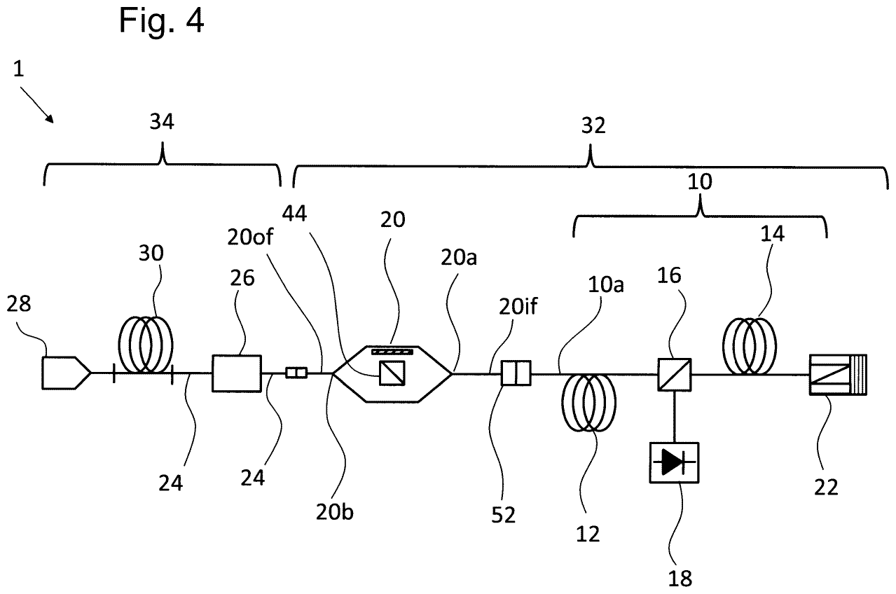

FIG. 4 illustrates a case where the axis roll connection portion 52 is separated from the single-polarization reflective polarizing beam splitter 20 and provided in the optical path 10. The configuration of the single-polarization reflective polarizing beam splitter 20 illustrated in FIG. 4 is a so-called pigtail configuration. In the pigtail configuration, the input fiber and the output fiber are provided in the single-polarization reflective polarizing beam splitter 20 in advance.

The input fiber and the output fiber are referred to as an input pigtail fiber 20if and an output pigtail fiber 20of, respectively. Note that, in the present invention, at least the input pigtail fiber 20if is a polarization maintaining fiber. Furthermore, the output pigtail fiber 20of may be dispensed with. FIG. 4 illustrates that the latter end of the output pigtail fiber 20of is joined to the fiber of the output unit 34 via a normal connector. In this manner, the single-polarization reflective polarizing beam splitter 20 may include the pigtails.

In the case of FIG. 4, the single-polarization reflective polarizing beam splitter 20 and the input pigtail fiber 20if are joined at the joining portion with the axes thereof (the polarization axes and the polarization maintaining axes) aligned with each other for connection without being twisted.

On the other hand, the input pigtail fiber 20if and the optical path fiber 10a are joined at the joining portion with the polarization maintaining axes thereof twisted. That is, the fast axis FA of the input pigtail fiber 20if and the fast axis FA of the optical path fiber 10a are twisted each other by the twisting angle θ. Therefore, in this case, the axis roll connection portion 52 is the joining portion between the input pigtail fiber 20if and the optical path fiber 10a.

Even with such a configuration, it can be said that a connection is established where a predetermined twisting angle is used as the twisting angle of the polarization maintaining axes of the optical path 10 with respect to the polarization axes of the light returned from the single-polarization reflective polarizing beam splitter 20 to the optical path 10. The reason for this is that the polarization maintaining axes of the input pigtail fiber 20if are aligned with the polarization axes of the polarizing beam splitter 44.

Furthermore, at the axis roll connection portion 52 in FIG. 4, the input pigtail fiber 20if and the optical path fiber 10a may be fusion-bonded while the polarization maintaining axes of the input pigtail fiber 20if and the optical path fiber 10a are twisted by the predetermined twisting angle θ. The “fusion-bonding” used herein is a mode of the “joining”. Since the fusion-bonding keeps the twisting angle θ of the respective polarization maintaining axes unchanged, the effect caused by twisting the polarization axes and the polarization maintaining axes can be stabilized and kept over time.

Furthermore, at the axis roll connection portion 52 in FIG. 4, the input pigtail fiber 20if and the optical path fiber 10a may be terminated using known connectors, and the joining portions of the connectors may be rotatable. In this case, the rotation of the connectors may be achieved not only by mechanically rotating the connectors in a state where the fibers butt against each other but also by, in order to rotate the axes, arranging collimators at the connectors and joining the connectors with use of spatial light in a state where the fibers are not directly joined. That is, a configuration to allow the twisting angle θ to be variable may be employed. More preferably, a mechanism is provided that can fix and release the joining state so that the twisting angle θ of the polarization maintaining axes is not changed.

### [½ Wave Plate Type]

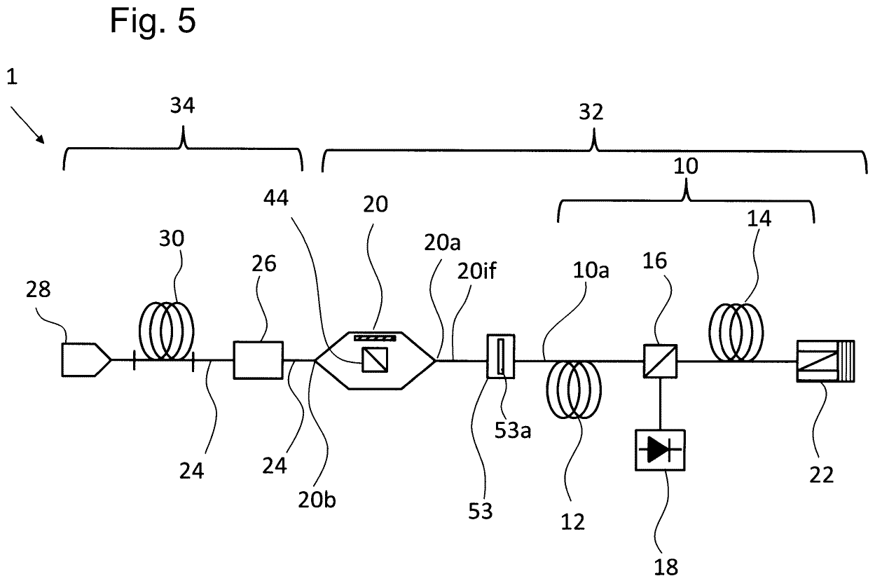

FIG. 5 illustrates a configuration of an axis roll connection portion 53, in which a ½ wave plate 53a is provided at the joining portion between the input pigtail fiber 20if and the optical path fiber 10a. The ½ wave plate 53a includes therein a fast axis (extraordinary axis) and a slow axis (ordinary axis). The ½ wave plate 53a tilts, by 2ϕ, the polarization plane of the linearly polarized wave, which is tilted by an angle ϕ with respect to the fast axis, and outputs the resulting linearly polarized wave. The polarization plane can be tilted by 2ϕ of up to 90°.

The axis roll connection portion 53 houses the ½ wave plate 53a in the housing thereof in a state where the ½ wave plate 53a is rotatable around the optical axis. The housing is provided on both sides thereof with through holes, and the input pigtail fiber 20if and the optical path fiber 10a are inserted in the through holes, respectively. In the case of the axis roll connection portion 53, the polarization maintaining axes of the input pigtail fiber 20if and the optical path fiber 10a do not need to be aligned with each other or twisted by the predetermined angle θ and fixed at the time of joining to the housing. The reason for this is that, whatever angle the polarization axes of the respective fibers have, the polarization axes of the input pigtail fiber 20if and the optical path fiber 10a can be aligned or can be set to have the predetermined twisting angle θ by rotating the ½ wave plate 53a. In this case as well, the ½ wave plate 53a is preferably allowed to be fixed so as not to move after adjustment.

### [½ Wave Plate Incorporation Type]

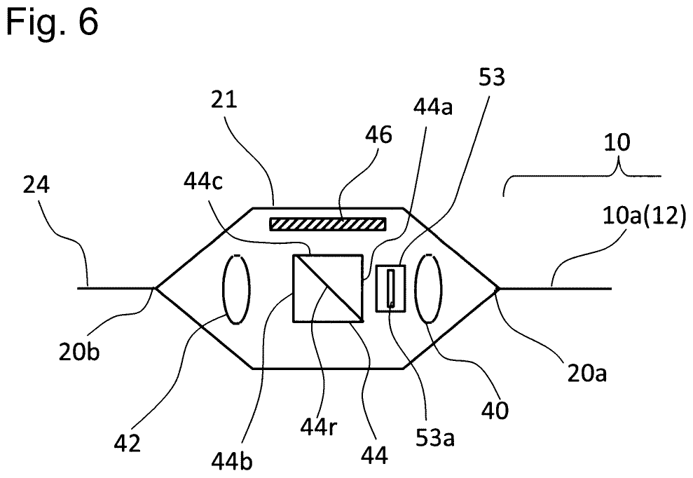

FIG. 6 illustrates a single-polarization reflective polarizing beam splitter 21 obtained by incorporating the axis roll connection portion 53 in the single-polarization reflective polarizing beam splitter 20. The axis roll connection portion 53 is arranged at the latter part relative to the incident lens 40 and before the polarizing beam splitter 44. In this case as well, the polarization axes of the polarizing beam splitter 44 and the polarization maintaining axes of the optical path fiber 10a can substantially be twisted by the predetermined twisting angle θ.

Light from the optical path fiber 10a is first converted into parallel light by the collimator (incident lens 40), passes through the ½ wave plate 53a, and is then transmitted through the polarizing beam splitter 44 to generate a component (P wave). The P wave is incident on the fiber in the output unit 34 (refer to FIG. 5) by means of the opposite collimator (exit lens 42) and is led to the highly nonlinear fiber 30. A reflected component (S wave) is reflected by the reflecting mirror 46. When passing through the ½ wave plate 53a again, the reflected component has the polarization axes thereof rotated by a predetermined angle, and is led to the resonator 32 through the first collimator (incident lens 40) on the right side.

By using the single-polarization reflective polarizing beam splitter 21 configured as above, angular adjustment between the polarization maintaining axes is unnecessary at the joining portions other than the joining portion between the optical path fibers 10a. Furthermore, it is only necessary to adjust the twisting angle θ of the polarization axes and the polarization maintaining axes by means of the ½ wave plate 53a after the 90° polarization-rotating reflector 22 and the optical path 10 are joined to the single-polarization reflective polarizing beam splitter 21. Not requiring an adjustment before joining facilitates the assembling of the resonator 32.

Note that, in the case of the incorporation type in FIG. 6 as well, the ½ wave plate 53a preferably has a rotation mechanism so that the angle between the main axis (fast axis) of the ½ wave plate 53a and the polarization axis of the polarizing beam splitter 44 can be adjusted. As described above, the twisting angle θ of the polarization axes and the polarization maintaining axes between the single-polarization reflective polarizing beam splitter 20 and the optical path fiber 10a can be adjusted using a method of fusion-bonding after determining the twisting angle, a method of mechanical rotation and fixing, or a method of optically adjusting the twisting angle. These methods may be referred to as an angular adjustment means and can be classified as a mechanical angular adjustment means and as an optical angular adjustment means.

Furthermore, the optical angular adjustment means used as the axis roll connection portion 52 may be another method, instead of the methods described above, that can adjust the twisting angle θ of the polarization axes and the polarization maintaining axes between the single-polarization reflective polarizing beam splitter 20 and the optical path fiber 10a. For example, the optical angular adjustment means may be configured by a so-called polarization controller obtained by combining a wave plate, a Faraday element serving as a non-reciprocal element, and the like.

Note that, in a configuration in which a polarization controller is joined to a normal fiber that is not a polarization maintaining fiber, as the state of the nonlinear polarization rotation occurring in the optical fiber changes due to disturbances, the resonance state itself of the resonator also changes, and the oscillation becomes unstable. Therefore, the polarization state needs to be adjusted each time. However, in the configuration according to the present invention, once the twisting angle θ between axes is determined, the polarization state does not need to be adjusted during laser oscillation. Thus, the configuration according to the present invention is different from the conventional configuration.

### <Output Unit>

Referring to FIG. 1 again, the output unit 34 is joined to the exit port 20b of the single-polarization reflective polarizing beam splitter 20. The output unit 34 is a unit that takes out of the resonator 32 the laser light generated in the resonator 32. Normally, the output unit 34 starts with an optical fiber 24 joined to the exit port 20b of the single-polarization reflective polarizing beam splitter 20. The optical fiber 24 is provided with the anti-reflector 26. The optical fiber 24 makes light pass therethrough only in one direction from the single-polarization reflective polarizing beam splitter 20 to the latter part. Note that, here, the “latter part (used in the same way below)” refers to a component located further in the output direction than a target component.

### <Anti-Reflector 26>

The anti-reflector 26 is an anti-reflection means for preventing reflected light from the outside from returning to the resonator 32. The anti-reflector 26 may not only be a device such as an isolator but may also be a means of obliquely polishing the connector end surface of the emitting end of the light-emitting port 28, or a means of applying a non-reflection coating to the connector end surface of the emitting end of the light-emitting port 28.

That is, in a case where any of the above treatments is done on the light-emitting port 28, it can be said that the anti-reflector 26 is provided. It can also be said that the anti-reflector 26 is provided at the exit port 20b of the single-polarization reflective polarizing beam splitter 20. Furthermore, the single-polarization reflective polarizing beam splitter 20 may have inside an equivalent function to that of the anti-reflector 26.

### <Light-Emitting Port 28>

The light-emitting port 28 is formed at the end portion of the anti-reflector 26. On the exit side of the single-polarization reflective polarizing beam splitter 20, optical pulses that the optical fiber output light source device 1 according to the present invention aims at have been prepared. Hence, as the optical fiber 24, a desired optical fiber may be used according to the use purpose of the optical fiber output light source device 1. For example, a polarization maintaining fiber may also be used here.

### <Highly Nonlinear Fiber 30>

To the latter part relative to the resonator 32, the highly nonlinear fiber 30, such as a photonic crystal fiber, may be joined. The highly nonlinear fiber 30 may be joined to the latter part relative to the anti-reflector 26. As described in Examples provided below, the optical fiber output light source device 1 according to the present invention exhibits a spectrum in which the output is stable over a broad wavelength range. Therefore, in a case where the output light from the optical fiber output light source device 1 is caused to pass through the highly nonlinear fiber 30, it is possible to obtain a light source that can output light having a broader spectral range in a stable manner. Note that, as the optical fiber 24, an optical fiber other than a transverse single mode fiber may be used. Furthermore, a polarization maintaining fiber may also be used here.

By joining the highly nonlinear fiber 30 having a zero dispersion characteristic with small dispersion, broadband spectral light generated by the resonator 32 can be turned into broader-band spectral light (super continuum (SC) light) and taken out.

More specifically, the “highly nonlinear fiber (30)” in the present invention is one that, in the effective spectral range of the laser light output from the resonator 32, has a region whose dispersion value range is from −1 to at most 3 [ps/(nm·km)] with zero dispersion at the center. Furthermore, the “highly nonlinear fiber (30)” is more preferably a fiber that has a region whose dispersion value range is from 0 to 1 [ps/(nm·km)].

Furthermore, the “highly nonlinear fiber (30)” is preferably a dispersion-flattened fiber in the effective spectral range. Preferably, in a case where the dispersion slope is ±0.1 [ps/(nm²·km)] or less, spectral broadening is available.

Here, the effective spectral range refers to a wavelength width at −30 dB from the maximum value of the envelope curve of the spectrum of the laser light output light from the resonator 32. Note that the effective spectral range may include a wavelength range without light. It is to be understood that the region whose dispersion value range is the range described above is a region (wavelength range) with light in the effective spectral range.

Furthermore, the single-polarization reflective polarizing beam splitter 20, the multiplexer 16, the anti-reflector 26, and the like serving as optical fiber input and output units may each be provided with a fiber in advance, and the fiber may be joined to the dispersion compensating fiber 12 or the amplifying optical fiber 14 by means of fusion-bonding or a connector.

### Description of Operation

First, a case where the optical path fiber 10a is not a polarization maintaining fiber (this case is the configuration in PTL 3) will be described.

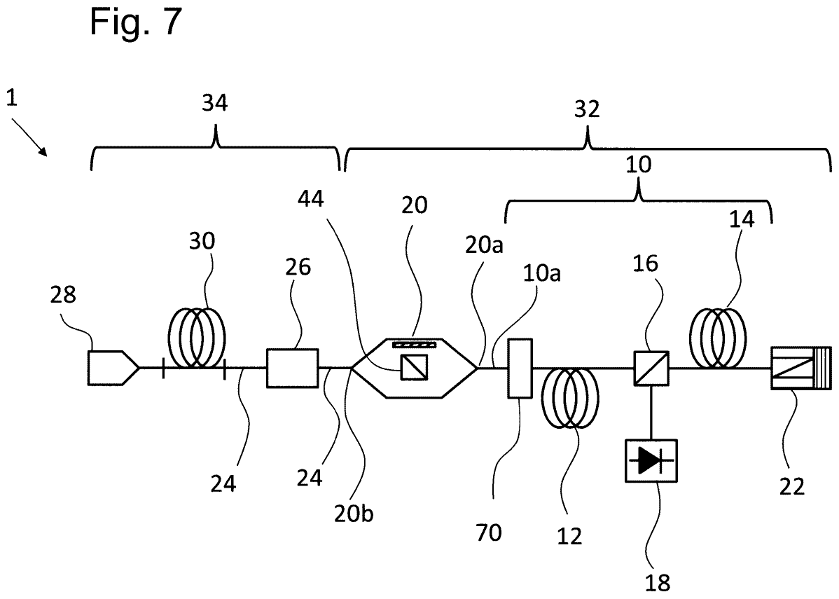

FIG. 7 illustrates the configuration in PTL 3. FIG. 7 and FIG. 1 are different from each other in that, in FIG. 7, the optical path fiber 10a is not a polarization maintaining fiber, no axis roll connection portion 52 is provided, and a bulk-type polarization controller 70 is provided. The other components are the same as those described above and are thus labeled with the same reference signs.

Light incident from the single-polarization reflective polarizing beam splitter 20 on the optical path 10 is reflected by the 90° polarization-rotating reflector (Faraday rotating mirror) 22 on the opposite side and returns. At this time, due to the effect of the 90° polarization-rotating reflector 22, the returned light has a linearly polarized wave orthogonal to the light incident from the single-polarization reflective polarizing beam splitter 20 on the optical path 10. This characteristic is maintained regardless of whether or not the optical path 10 is a polarization maintaining fiber as long as linear propagation is performed.

When the power of the light in the optical path 10 increases, a phase shift due to a nonlinear optical effect such as self-phase modulation and cross-phase modulation occurs. The phase shift exhibits an effect that the polarization state changes, which is nonlinear polarization rotation. The polarization state changes only at a portion having strong light power, and the polarization component in the same direction as the incident linearly polarized wave expands. For this reason, as for the light returned from the 90° polarization-rotating reflector 22, the polarized wave turns into an elliptical shape as compared with the linearly polarized wave traveling toward the 90° polarization-rotating reflector 22, and the component that is reflected by the single-polarization reflective polarizing beam splitter 20 is generated as well as the component that is transmitted therethrough.

The light component can repetitively be amplified, and the light power gets stronger. As a result, short pulses having high light power grow, and pulsed oscillation occurs. However, to cause the polarized wave to turn into an elliptical shape, adjustment is required so as to cause the nonlinear polarization rotation that promotes generation of the component that can repetitively be amplified in the optical path fiber 10a. This point is thought to be a cause for making laser oscillation difficult.

Conversely, the polarization maintaining fiber causes stress to be generated in the fiber due to its special structure and has two orthogonal axes that maintain the linear polarization of the propagating light. The two axes that maintain the polarization are called a fast axis and a slow axis that have different phase velocity values. As the names indicate, the fast axis is an axis having a fast propagation velocity while the slow axis is an axis having a slow propagation velocity. Due to the difference in propagation velocity, power of light incident on the fast axis and power of light incident on the slow axis are maintained without being mixed.

For this reason, in a case where a linearly polarized wave is made incident on either the fast axis or the slow axis, the linearly polarized wave is output in a state where it is maintained. In a case where polarized light that is not aligned with the polarization maintaining axes, such as tilted linearly-polarized light, is made incident, the light through the fast axis and the light through the slow axis propagate independently and are synthesized again at the time of output. Since the propagation velocity on the fast axis is different from that on the slow axis, the phases of the light transmitted through the respective axes are different. Therefore, even the tilted linearly polarized wave at the time of entering turns into an elliptical shape in accordance with the phase difference at the time of propagation.

This phenomenon will be described in detail with reference to FIG. 3 (c). A linearly polarized wave D is made incident on the incident side. At this time, the polarization maintaining axes of the polarization maintaining fiber are twisted by the twisting angle θ with respect to the linearly polarized wave D. The light is divided into a component Df in the direction of the fast axis FA and a component Ds in the direction of the slow axis and travels through the fiber. While the light passes through the fiber, the light is subjected to disturbances. As a result, the nonlinear polarization rotation occurs, and the polarized wave turns into an elliptical shape. Therefore, the polarized wave becomes an elliptically-polarized wave DT on the exit side. However, the power of the component Df in the direction of the fast axis FA and the power of the component Ds in the direction of the slow axis are maintained.

That is, light incident from the single-polarization reflective polarizing beam splitter 20 on the optical path fiber 10a is a linearly polarized wave at the time of entering the optical path 10, but the linearly polarized wave is input into the fast axis FA and the slow axis LA of the polarization maintaining fiber at the axis roll connection portion 52a as a tilted linearly polarized wave. Accordingly, the light returned from the 90° polarization-rotating reflector 22 surely turns into an elliptically-polarized wave due to the influence of the nonlinear polarization rotation. For this reason, there surely exists a component that is reflected by the single-polarization reflective polarizing beam splitter 20 without passing through it. Hence, oscillation occurs easily, and the oscillation state becomes stable.

Furthermore, in other words, in the case of an ordinary fiber, which is not a polarization maintaining fiber, there is no unique polarization axis, and the axis of the nonlinear polarization rotation is not thus fixed. For this reason, when the temperature, the bending stress, and the like change, the size and the rotating direction of the nonlinear polarization rotation also change. As a result, the operation of the light source is influenced by disturbances.

On the other hand, although the phase shift due to the nonlinear optical effect similarly occurs in the polarization maintaining fiber as well, the light power does not exchange at each axis. Thus, ease of occurrence of the nonlinear polarization rotation is determined only by the amount of light incident on each axis. That is, even with disturbances, ease of occurrence of the nonlinear polarization rotation is not influenced by the disturbances such as the temperature and the bending stress and can be controlled by a power ratio between the fast axis FA and the slow axis LA. As illustrated in FIG. 3, the power ratio is uniquely determined by the twisting angle θ of the axes (the polarization axes and the polarization maintaining axes) when the single-polarization reflective polarizing beam splitter 20 and the optical path fiber 10a are joined. Therefore, adjustment during the operation is not needed at all.

### Examination Method

In the optical fiber output light source device 1 according to the present invention, whether or not the axis roll connection portion 52 (or 53, hereinbelow, the axis roll connection portion 52 is used as a representative) is formed is important. A description will now be given of a method of examining whether or not the axis roll connection portion 52 is formed in the resonator 32 assembled actually.

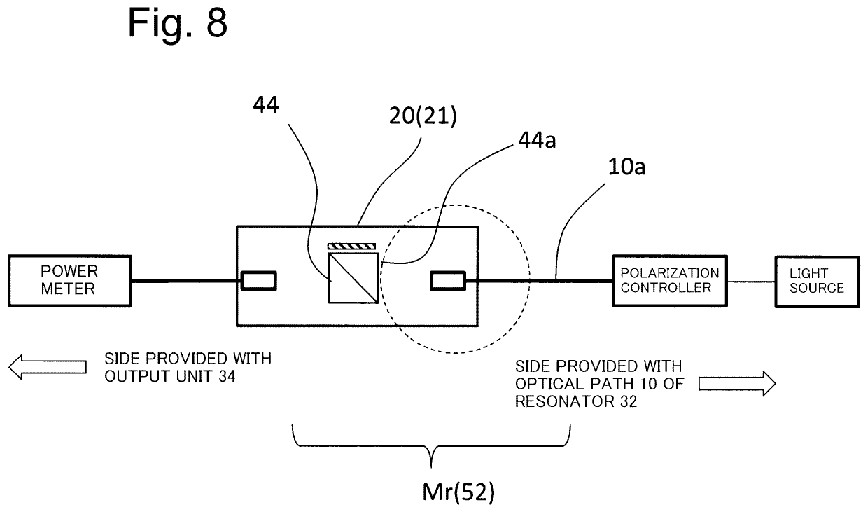

Referring to FIG. 8, the axis roll connection portion 52 is arranged between the incident light surface 44a of the polarizing beam splitter 44 in the single-polarization reflective polarizing beam splitter 20 and the optical path fiber 10a. The range between them is set as a measurement range Mr.

A polarization controller and a light source are arranged outside of the measurement range Mr. Then, a power meter is arranged on the exit port side of the single-polarization reflective polarizing beam splitter 20.

The examination method is as follows. Output light from the light source is made incident on the measurement range Mr via the polarization controller to measure the power of the output light. By adjusting the polarization controller, maximum power Pmax and minimum power Pmin can be measured. Here, a ratio (Pmin/Pmax) between the minimum power Pmin and the maximum power Pmax is a value called a polarization extinction ratio.

Similarly, a reference in which the polarization axes of the polarizing beam splitter 44 and the polarization maintaining axes of the optical path fiber 10a are aligned with each other in advance is prepared, and the polarization extinction ratio is measured in a similar manner.

When the polarization extinction ratio of the device under test is significantly lower than the polarization extinction ratio of the reference, this shows that the twisting angle θ between the polarization axes and the polarization maintaining axes is intentionally twisted at the portion indicated by the dotted circle in FIG. 8.

For example, when the polarization axes of the polarizing beam splitter 44 and the polarization maintaining axes of the optical path fiber 10a are aligned with each other, the value of the polarization extinction ratio is about 20 dB. When the twisting angle θ is set to about 10 degrees, the value becomes as low as about 15 dB. Therefore, in a case where whether or not the axis roll connection portion 52 produced complies with the specification is unknown, or where the twisting angle θ is unknown, it is possible to examine whether or not the twisting angle θ is set by the aforementioned method.

### EXAMPLES

### Example 1

An operation example in the configuration in FIG. 4 from which the highly nonlinear fiber 30 in the output unit 34 is eliminated is described below. As the amplifying optical fiber, a polarization maintaining erbium doped fiber (EDF) was used.

Furthermore, as the dispersion compensating fiber 12, a polarization maintaining single mode fiber was used, so that the entire optical path 10 was made of a polarization maintaining fiber. As the pumping light source 18, a 1480-nm band semiconductor laser was used. The input pigtail fiber 20if on the side of the single-polarization reflective polarizing beam splitter 20 provided with the optical path 10 was also made of a polarization maintaining fiber, and the polarization axes thereof were tilted by 15 degrees when the input pigtail fiber 20if is joined to the optical path fiber 10a by means of fusion-bonding.

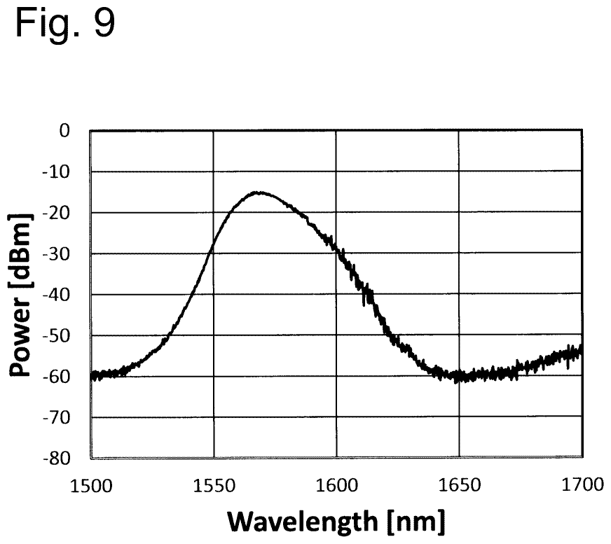

FIG. 9 illustrates an output light spectrum during the operation. Referring to FIG. 9, the horizontal axis represents the wavelength (nm), and the vertical axis represents the power (dBm) of the output light from the anti-reflector 26. A gentle light spectrum specific to the pulsed light was observed, and pulsed oscillation occurred in a stable manner. Furthermore, the light spectrum did not change as time passed, and stable pulsed oscillation continued.

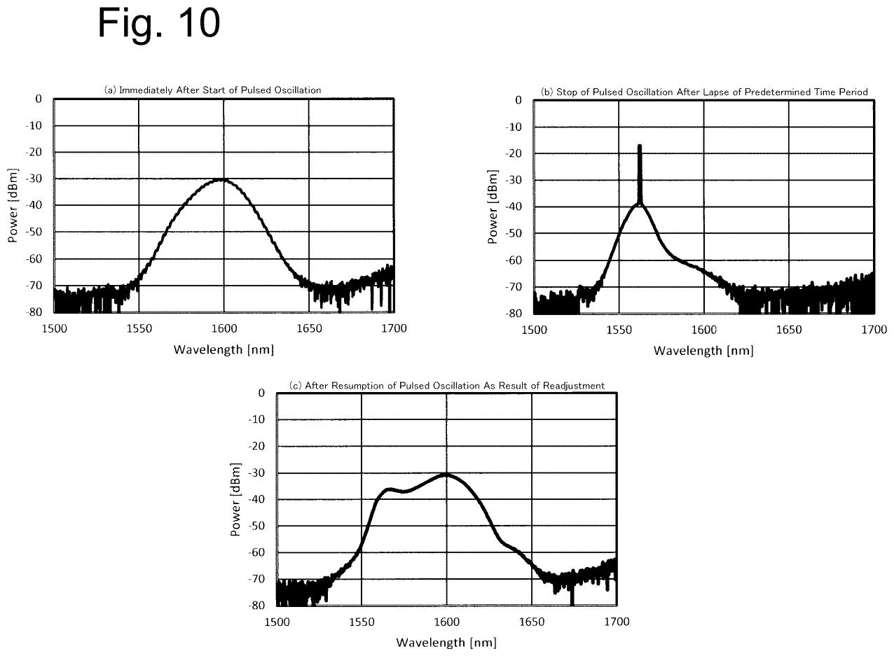

To show the effect of stability obtained by using the polarization maintaining fiber, similar measurement was performed in a conventional configuration not using the polarization maintaining fiber. The result is shown in FIG. 10. This is the configuration illustrated in FIG. 7 (the highly nonlinear fiber 30 is eliminated from the configuration). As the amplifying optical fiber 14, a normal EDF that does not maintain the polarization was used. Furthermore, as the dispersion compensating fiber 12, a normal fiber, not a polarization maintaining fiber, was used. In each of the graphs in FIG. 10, the horizontal axis represents the wavelength (1500 nm to 1700 nm), and the vertical axis represents the power (dBm) of the output light.

Adjustment was performed using the polarization controller 70, and oscillation was started as in FIG. 10 (a). In FIG. 10 (a), a gentle light spectrum specific to the pulsed light was observed. However, the output spectrum changed as time passed, pulsed oscillation was stopped as in FIG. 10 (b), and the spectrum was changed into a light spectrum having a line spectrum.

Adjustment was performed again using the polarization controller 70, and pulsed oscillation was resumed as in FIG. 10 (c). However, the spectrum did not get back to the shape in FIG. 10 (a). Furthermore, it was expected that the light spectrum would change, and that pulsed oscillation would stop again with time. As a result, readjustment was required in accordance with the changes of the external environment.

### Example 2

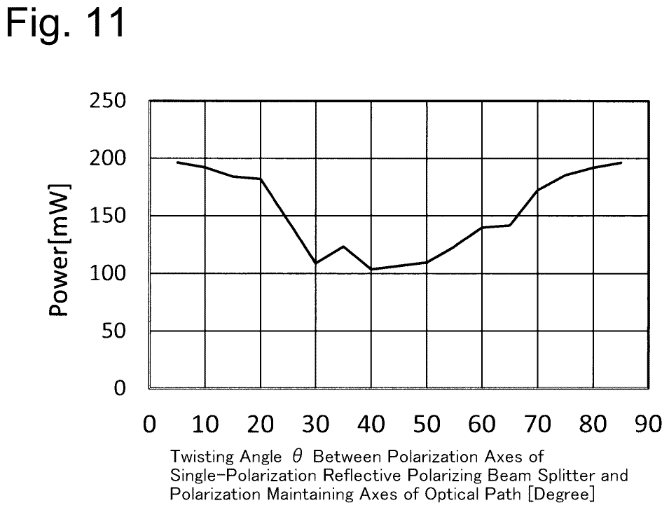

FIG. 11 shows an example of measurement results of output light power from the single-polarization reflective polarizing beam splitter 20 while the twisting angle θ between the polarization axes of the single-polarization reflective polarizing beam splitter 20 and the polarization maintaining axes of the optical path 10 was changed. Light did not pass through the highly nonlinear fiber 30. Referring to FIG. 11, the horizontal axis represents a twisting angle θ (degrees) between the polarization axis of the single-polarization reflective polarizing beam splitter 20 and the polarization maintaining axis of the optical path fiber 10a, and the vertical axis represents the light power (mW). This graph shows that, when the output light power from the single-polarization reflective polarizing beam splitter 20 increases, the laser light cannot be confined in the optical path 10, and it can be determined that stable oscillation cannot be achieved.

Stable oscillation was confirmed in a relatively wide range of from about 25 degrees to 65 degrees. However, when the twisting angle θ is close to 0 degrees or 90 degrees, that is, when the angle is extremely shallow, the light power is localized on one side of the axis, and therefore, the light propagates in a substantially linearly polarized state in forward and return directions. That is, the light passes through the single-polarization reflective polarizing beam splitter 20 without producing reflected light. Therefore, nonlinear polarization rotation is less likely to occur, and pulsed oscillation is less likely to occur. A suitable twisting angle θ between the polarization axes of the single-polarization reflective polarizing beam splitter 20 and the polarization maintaining axes of the optical path fiber 10a may be appropriately selected in consideration of the pulse shape, the length of the fiber, and the like.

### Example 3

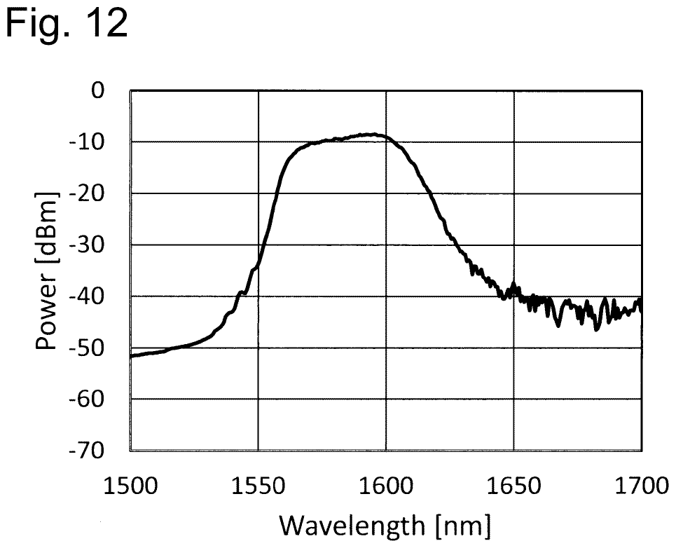

FIG. 12 shows an operation example in a configuration in which the axis roll connection portion 53 using the ½ wave plate 53a illustrated in FIG. 5 is incorporated. A polarization maintaining EDF was used as the amplifying optical fiber 14, and a polarization maintaining fiber was also used as the dispersion compensating fiber 12. The ½ wave plate 53a was fixed by a holder having a rotating mechanism. A collimator composed of polarization maintaining fibers was arranged at both ends, thereby forming a fiber module. Then, it was inserted between the single-polarization reflective polarizing beam splitter 20 and the optical path 10. FIG. 12 is a graph showing the measurement of an output light spectrum obtained when the fast axis of the ½ wave plate 53a is tilted by about 20 degrees with respect to the polarization maintaining axes of the optical path fiber 10a.

Referring to FIG. 12, the horizontal axis represents a wavelength (nm), and the vertical axis represents the light power (dBm). Pulsed oscillation was confirmed, and there was little change in the light spectrum for a long time as in the previous example (FIG. 9).

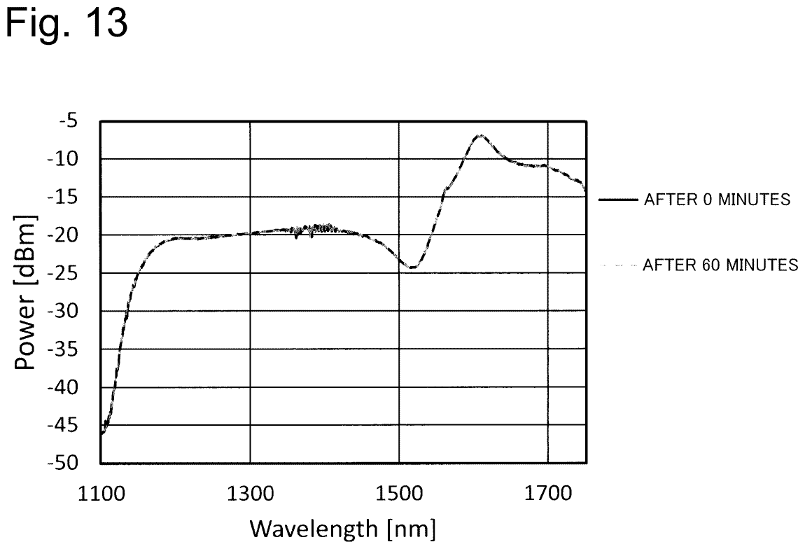

Furthermore, FIG. 13 shows a broadband light spectrum obtained by injecting this output into the highly nonlinear fiber 30. In FIG. 13, the measurement immediately after the start of oscillation (after 0 minutes) and the measurement after the continuous operation for 60 minutes are overlapped. The two graphs almost overlapped and were very stable both in terms of spectral shape and power.

As shown in FIG. 10, it can be said that instability is eliminated as in the present invention, the instability being such that, when the polarization maintaining fiber is not used, the spectral shape of the output changes or the spectral shape becomes different from the original state even if the laser oscillation starts again by readjustment.

Since the output from the single-polarization reflective polarizing beam splitter 20 is stabilized, the process of supercontinuum occurrence in the highly nonlinear fiber 30 is also stabilized. As a result, an ideal light source with little temporal variation in the broadband light spectrum is obtained. Such a high stability is advantageous in applying the light source to an optical component inspection, a sensor, or the like.

### Example 4

As a further improvement of the configuration illustrated in FIG. 5 (the configuration using the axis roll connection portion 53 using the ½ wave plate 53a), as illustrated in FIG. 6, the single-polarization reflective polarizing beam splitter 20 and the axis roll connection portion 53 using the ½ wave plate 53a can be integrated. With this configuration, the number of fiber components can be reduced, and the assembly cost can be reduced.

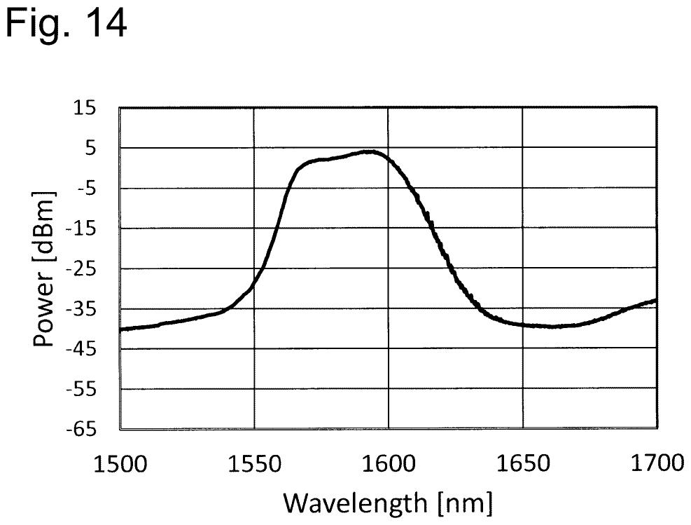

FIG. 14 shows an output spectrum when a laser in which the single-polarization reflective polarizing beam splitter integrated with a ½ wave plate 21 as illustrated in FIG. 6 is installed is oscillated. In FIG. 14, the horizontal axis represents wavelengths (nm) and the vertical axis represents the light power (dBm). It was confirmed that the pulsed light with a gentle expansion of spectrum was generated, and change over time was hardly observed.

### INDUSTRIAL APPLICABILITY

The optical fiber output light source device according to the present invention can be suitably used as a light source for various measurements.

### REFERENCE SIGNS LIST

1 optical fiber output light source device
10 optical path
10a optical path fiber
12 dispersion compensating fiber
14 amplifying optical fiber
16 multiplexer
18 pumping light source
20 single-polarization reflective polarizing beam splitter
20a incident port
20b exit port
20if input pigtail fiber
20of output pigtail fiber
21 single-polarization reflective polarizing beam splitter
24 optical fiber
22 90° polarization rotating reflector
26 anti-reflector
30 highly nonlinear fiber
28 light-emitting port
32 resonator
34 output unit
40 incident lens
42 exit lens
44 polarizing beam splitter
44a incident light surface
44b transmitted light surface
44c reflected light surface
44x reflection surface
46 reflecting mirror
52 axis roll connection portion
53 axis roll connection portion
53a ½ wave plate

1. An optical fiber output light source device comprising:
an optical path that is obtained by joining a polarization maintaining amplifying optical fiber to a polarization maintaining dispersion compensating fiber;
a single-polarization reflective polarizing beam splitter that is joined to one end of the optical path;
a 90° polarization-rotating reflector that is joined to another end of the optical path;
a multiplexer that is inserted in the optical path; and
a pumping light source that is joined to the multiplexer,
wherein an axis roll connection portion is provided in which a polarization axis of light returned from the single-polarization reflective polarizing beam splitter to the optical path is connected to a polarization maintaining axis of the optical path with a twisting angle therebetween at a predetermined angle.

2. The optical fiber output light source device according to claim 1, wherein the axis roll connection portion includes an angular adjustment means that adjusts the twisting angle between the polarization axis of the light returned from the single-polarization reflective polarizing beam splitter to the optical path and the polarization maintaining axis of the optical path.

3. The optical fiber output light source device according to claim 1, wherein the axis roll connection portion includes a ½ wave plate that is inserted in a rotatable manner with respect to an optical axis in between the optical path and the light returned from the single-polarization reflective polarizing beam splitter to the optical path.

4. The optical fiber output light source device according to claim 1, wherein
the axis roll connection portion includes:
a polarization maintaining fiber through which the light returned from the single-polarization reflective polarizing beam splitter to the optical path passes; and
a fusion-bonding portion where the fibers are fusion-bonded while the twisting angle of the polarization maintaining axes of the optical path is kept at the predetermined angle.

5. The optical fiber output light source device according to claim 1, wherein the single-polarization reflective polarizing beam splitter uses a Faraday rotating mirror.

6. The optical fiber output light source device according to claim 1, further comprising a highly nonlinear fiber that is joined to a latter part relative to the single-polarization reflective polarizing beam splitter.

7. A single-polarization reflective polarizing beam splitter comprising:
a polarizing beam splitter;
a reflecting mirror opposed to a reflection surface of the polarizing beam splitter;
an incident lens arranged on a side closer to an incident light surface of the polarizing beam splitter;
an exit lens arranged on a side closer to a transmitted light surface of the polarizing beam splitter; and
a ½ wave plate arranged on an incident side more than the incident lens.
